(19) United States
(12) Patent Application Publication
(10) Pub. No.: US 2024/0191770 A1
(43) Pub. Date: Jun. 13, 2024

(54) HYDRAULIC DAMPER

(71) Applicant: THE DYNAMIC ENGINEERING SOLUTION PTY LTD, South Australia (AU)

(72) Inventor: Michael NEWSTEAD, South Australia (AU)

(73) Assignee: THE DYNAMIC ENGINEERING SOLUTION PTY LTD, South Australia (AU)

(21) Appl. No.: 18/286,698

(22) PCT Filed: Apr. 12, 2022
(86) PCT No.: PCT/AU2022/050327

§ 371 Date: Oct. 12, 2023

(30) Foreign Application Priority Data
Apr. 12, 2021 (AU) 2021901055

(51) Int. Cl. F16F 9/512

(52) U.S. Cl. CPC F16F 9/5126; F16F 2228/04

(57) ABSTRACT

A hydraulic damper comprising a main cylinder, a piston slidably moveable within the main cylinder in compression and extension, the piston dividing the main cylinder into a main fluid chamber and an annulus fluid chamber, a piston rod extending from the piston through the annulus fluid chamber, and wherein the piston comprises a frequency sensitive damping (FSD) valve assembly configured to create a piston by-pass above a specified damper frequency, and further configured to lock the length of the hydraulic damper.

### PRIORITY DOCUMENTS

The present application claims priority from Australian Provisional Patent Application No. 2021901055 titled “HYDRAULIC DAMPER” and filed on 12 Apr. 2021, the content of which is hereby incorporated by reference in its entirety.

### TECHNICAL FIELD

The present disclosure relates to a hydraulic damper, and a frequency sensitive damping (FSD) valve assembly for a hydraulic damper.

### BACKGROUND

A hydraulic damper converts kinetic energy into heat energy using viscous friction of a non-compressible fluid (such as hydraulic oil). Typically, this is achieved by passing oil through restricted apertures (also known as ports) and valve mechanisms (such as shim stacks on either side of the apertures) which generate hydraulic resistance. Damping coefficient adjustments can be made by varying the aperture size and/or varying the configuration of the valve mechanism.

Existing passive dampers of this type comprise a position based piston by-pass to reduce heat generation with low amplitude input at ride height. However, these could not be integrated with a wheel locking system.

It is against this background and the problems and difficulties associated therewith that the present invention has been developed.

Certain objects and advantages of the present invention will become apparent from the following description, taken in connection with the accompanying drawings, wherein, by way of illustration and example, an embodiment of the present invention is disclosed.

### SUMMARY

According to a first aspect, there is provided a hydraulic damper comprising a main cylinder, a piston slidably moveable within the main cylinder in compression and extension, the piston dividing the main cylinder into a main fluid chamber and an annulus fluid chamber, a piston rod extending from the piston through the annulus fluid chamber, wherein the piston comprises a frequency sensitive damping (FSD) valve assembly configured to create a piston by-pass above a specified damper frequency, and is further configured to lock the length of the hydraulic damper.

In one form, the hydraulic damper further comprises a reservoir, a first fluid passage extending between the annulus fluid chamber and the reservoir, a second fluid passage extending between the reservoir and the main fluid chamber, and a check valve positioned between the reservoir and the main fluid chamber to prevent flow from the main fluid chamber to the reservoir via the second fluid passage.

In one form, wherein in use, during a compression stroke, the check valve remains closed, and fluid in the main fluid chamber is passed by and through the FSD valve assembly to the annulus fluid chamber and then the reservoir via the first fluid passage.

In one form, wherein in use, during an extension stroke, fluid is drawn from the reservoir to the main fluid chamber via the second fluid passage and check valve.

In one form, the FSD valve assembly comprises a main spool valve comprising a main poppet biased to prevent fluid from the main fluid chamber from bypassing the FSD valve assembly to the annulus fluid chamber, the main poppet comprising a control orifice through which fluid can pass from the main fluid chamber to a backside thereof, and a pilot valve comprising a pilot poppet biased to prevent fluid passing from a backside of the main spool valve to the annulus fluid chamber via a pilot exhaust passageway, wherein when pressure within the main fluid chamber exceeds the force exerted on the pilot poppet, the pilot poppet opens and fluid is released behind the main poppet through the pilot exhaust passageway, wherein the resultant pressure drop across the control orifice opens the main poppet, allowing fluid to flow from the main fluid chamber to the main fluid chamber, and when pressure within the main fluid chamber falls below the force exerted on the pilot poppet, the pilot poppet closes, preventing the release of fluid behind the main poppet through the pilot exhaust passageway, wherein pressure equalises across the control orifice and the main poppet closes.

In one form, the main poppet is biased to prevent fluid from the main fluid chamber from bypassing the FSD valve assembly to the annulus fluid chamber by a main spring.

In one form, the pilot poppet is biased to prevent exhaust of fluid from a backside of the main spool valve to the annulus fluid chamber by a pilot spring.

In one form, the FSD valve assembly further comprises a blocking piston in fluid communication with a fluid supply for supplying a pilot fluid to the damper, the blocking piston biased against the fluid supply and the pilot poppet by the pilot spring, such that a variation of pressure exerted on the blocking piston by the fluid supply will vary the extent of bias applied to close the pilot poppet by the pilot spring.

In one form, locking the length of the damper is effected when supply fluid is supplied against the blocking piston increasing an extent of bias applied to close the pilot valve, meaning no fluid can be exhausted from behind the main spool valve, meaning no fluid is passed from the main fluid chamber to annulus fluid chamber, and the length of the damper is locked.

In one form, the fluid supply for supplying fluid to the damper comprises a vehicle hydraulic system.

In one form, the hydraulic damper further comprises a flow regulating valve positioned between the annular fluid chamber and the reservoir.

According to a second aspect, there is provided a hydraulic damper comprising a main cylinder comprising a first end and a second end, a reservoir comprising an elongate body comprising a first end and a second end, the reservoir being positioned alongside of the main cylinder, a first fluid gallery extending between an annulus fluid chamber of the main cylinder and the reservoir at or toward the first end of each, a second fluid gallery extending between the reservoir and a main fluid chamber of the main cylinder and at or toward the second end of each, a flow regulating valve positioned between the first fluid gallery and the reservoir, a check valve positioned between the reservoir and the second fluid gallery to prevent back-flow from the main fluid chamber via the second fluid gallery, a piston slidably moveable within the main cylinder in compression and extension, the piston dividing the main cylinder into the main fluid chamber and the annulus fluid chamber, a piston rod extending from the piston through the annulus fluid chamber, the piston rod comprising a pilot fluid passageway extending therethrough from a first end, which is in fluid communication with the main fluid chamber, to a second end in fluid communication with a fluid supply for supplying a pilot fluid to the damper, and wherein the piston comprises a frequency sensitive damping (FSD) valve assembly which is positioned in the first end of the rod piston fluid passageway, which creates a piston by-pass above a specified damper frequency, and which locks the length of the damper when the fluid supply supplies pilot fluid to the damper.

According to a third aspect, there is provided a frequency sensitive damping (FSD) valve assembly for a hydraulic damper, the FSD valve assembly comprising a main spool valve and a pilot valve which regulates the functioning of the main spool valve, and which itself is regulated by a pilot fluid supply.

In one form, the main spool valve comprises a main poppet biased to prevent fluid from a main fluid chamber from bypassing the FSD valve assembly to an annulus fluid chamber, a pilot valve comprising a pilot poppet biased to prevent fluid passing from a backside of the main spool valve to the annulus fluid chamber and to vary a degree of bias of the main spool valve, and a blocking piston biased against a fluid supply and the pilot poppet so as to vary a degree of bias of the pilot poppet.

### BRIEF DESCRIPTION OF DRAWINGS

Embodiments of the present disclosure will be discussed with reference to the accompanying drawings wherein:

FIGS. 1 through 3 are cross-sectional views of an hydraulic damper; and

FIG. 4 is a cross-sectional view of a frequency sensitive damping (FSD) valve assembly from the damper of FIGS. 1 through 3.

In the following description, like reference characters designate like or corresponding parts throughout the figures.

### DESCRIPTION OF EMBODIMENTS

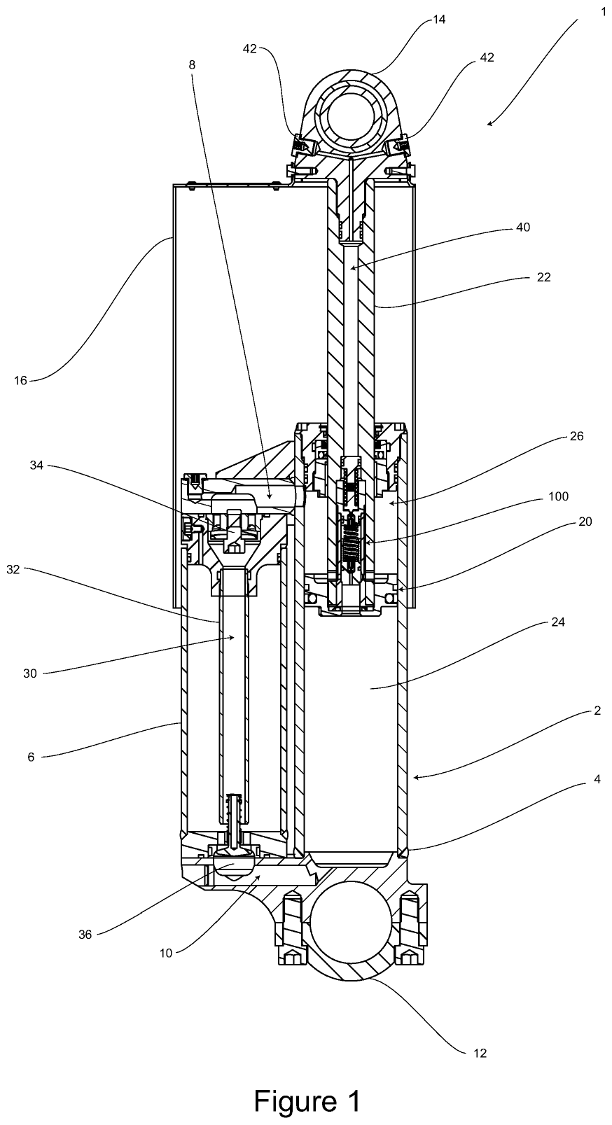

Referring now to FIGS. 1 through 3, there is shown a hydraulic damper 1 according to an embodiment. The damper 1 comprises a main body 2 comprising a main cylinder 4 and a reservoir cylinder 6 positioned alongside of the main cylinder 4, a first fluid gallery 8 extending between the main cylinder 4 and the reservoir cylinder 6 at a first end of each, and a second fluid gallery 10 extending between the main cylinder 4 and the reservoir cylinder 6 at a second end of each. A first mounting eyelet 12 is provided on an end of the main body 2.

There is a piston 20 retained so as to be slidably moveable within the main cylinder 4 in compression and rebound, and a piston rod 22 extending from the piston 20 and out of the main cylinder 4, which terminates in a second mounting eyelet 14. A shroud 16 extends down from the second eyelet 14 and around the main body 2. The main body 2 can be retracted within the shroud 16 as the damper 1 compresses, and extend therefrom as the damper rebounds.

The main cylinder 4 comprises a main bore having an internal volume, in which the piston 20 slides. The piston 20 divides the main bore into a main fluid chamber 24 and an annulus fluid chamber 26 around the piston rod 22.

The reservoir cylinder 6 encloses a reservoir 30 comprising an elongate body 32 extending lengthwise through the reservoir cylinder 6 from the first fluid gallery 8 toward the second fluid gallery 10. This body 32 is a cylinder which terminates at an opening adjacent to the second gallery 10. In use, fluid is intended to enter the reservoir cylinder 6 via the first fluid gallery 8 where it will then drain from the opening in the cylinder 32 adjacent to the second gallery 10 and fill the reservoir 30. Fluid is intended to exit the reservoir cylinder 6 via the second fluid gallery. It will be appreciated that a proportion of the volume of the reservoir will be filled with fluid and the remainder with unpressurised gas.

While in the embodiment shown, fluid drains from the cylinder 32 by virtue of an opening adjacent the second gallery 10, in an alternate embodiment, the cylinder 32 may feature a plurality of apertures adjacent the second gallery 10 from which fluid may drain in to the reservoir 30.

The first fluid gallery 8 extends between the annulus fluid chamber 26 of the main cylinder 4 and the reservoir 30 at or toward the first end of each.

The second fluid gallery 10 extends between the reservoir 30 and the main fluid chamber 24 of the main cylinder 4 at or toward the second end of each.

A flow regulating valve 34 is positioned between the first fluid gallery 8 and the reservoir 30. The flow regulating valve 34 may be in the form of an orifice, pressure relief, shim stack, flow control valve, or any other type of flow regulating valve that provides resistance to fluid flow.

A check valve 36 is positioned between the reservoir 30 and the second fluid gallery 10 to prevent flow from the main fluid chamber 24 via the second fluid gallery 10 in to the reservoir 30 during a compression stroke.

The piston rod 22 comprises a fluid passageway 40 extending therethrough from a first end, which is in fluid communication with the main fluid chamber 24, to a second end in fluid communication with a fluid supply for supplying pilot fluid to the damper 1. More particularly, in this embodiment, the fluid passageway 40 is continued through the second (upper in this case) mounting eyelet 14 to a threaded aperture 42 for receiving a connection fitting. In the embodiment shown, the fluid passageway extends to a pair of threaded apertures 42. The use of two threaded apertures enables the hydraulic damper 1 to mount in at least two orientations, where a first aperture is intended to be connected to the fluid supply, with the second receiving a blank. In an alternate arrangement, it may also be possible for multiple hydraulic dampers to be connected to one another in series. For example a first hydraulic damper could have its first aperture connected to the fluid supply and its second aperture connected to a first aperture of a second hydraulic damper, and so on.

The fluid supply will form part of a hydraulic system of the vehicle to which the damper 1 is mounted.

A frequency sensitive damping (FSD) valve assembly 100 is positioned in the first end of the fluid passageway 40.

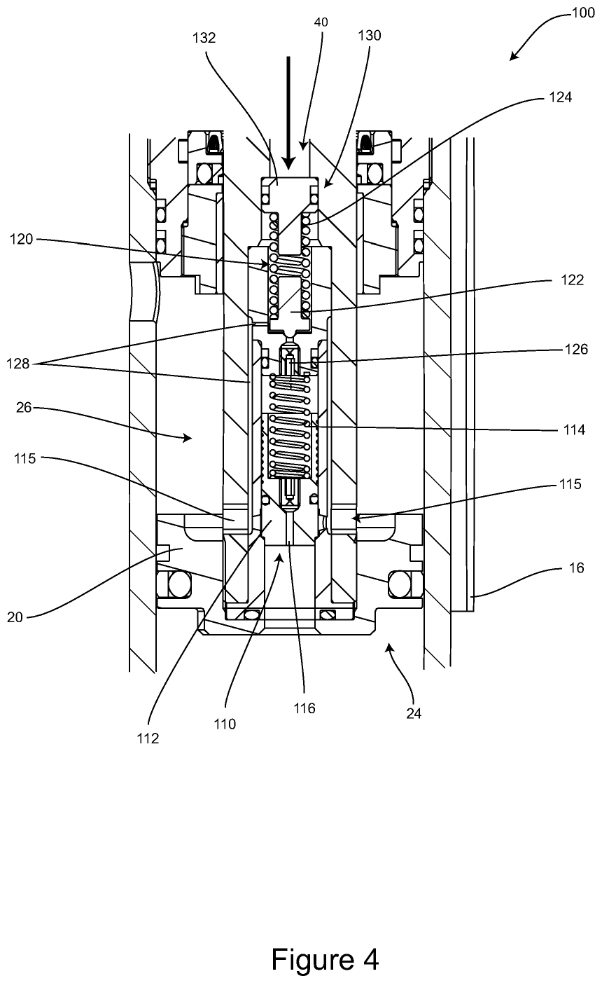

Referring now to FIG. 4, the FSD valve assembly 100 comprises a main spool valve 110 comprising a main poppet 112 biased by a main spring 114 to prevent fluid from the main fluid chamber 24 from bypassing the FSD valve assembly 100 to the annulus fluid chamber 26. When the main poppet 112 is seated in its closed position, it blocks bypass exhaust ports 115 which extend through a body of the main spool valve 110 and the piston rod 22.

The main poppet 112 comprises a control orifice 116 through which fluid can pass from the main fluid chamber 24 to a backside thereof so that pressure on the backside of the main poppet 112 may equalise with pressure on the front side (i.e. in the main fluid chamber 24). It will be appreciated that as a result of the combination of the pressure and the main spring 114 acting on the backside of the main poppet, that the main poppet 112 is prevented from opening.

The FSD valve assembly 100 further comprises a pilot valve 120 comprising a pilot poppet 122 biased by a pilot spring 124 to a closed position where it blocks an inlet 126 to the pilot valve 120 and prevents fluid passing to a pilot exhaust passageway 128 extending to the bypass exhaust ports 115. It will be appreciated that when the system pressure exceeds the force exerted on the pilot poppet 122 by the pilot spring 124, that fluid is released behind the main poppet 112 through the pilot exhaust passageway 128. The resulting pressure drop across the control orifice 116 opens the main poppet 112 and fluid is able to flow to the annulus fluid chamber 26 via the bypass exhaust ports 115.

The FSD valve assembly 100 further comprises a blocking valve 130 comprising a piston 132 biased by the pilot spring 124 against the pilot fluid supply provided via the fluid passageway 40 in the piston rod 22.

The blocking piston 132 is directed in an opposite direction to the pilot poppet 122, and the pilot spring 124 extends between these and bears against a backside of each. In use, fluid pressure in the fluid passageway 40 can be increased (by activation of a pump) as required until the blocking piston 132 is moved against the bias of the pilot spring 124, shortening this spring 124 and increasing its spring rate, and thus increasing the amount of bias acting against the pilot poppet 122. It will, of course, be appreciated that fluid pressure in the fluid passageway 40 can also be reduced, lengthening the pilot spring 124 and reducing its spring rate, and thus reducing the amount of bias acting against the pilot poppet 122. In this way, the pilot supply can be used to regulate operation of the pilot valve 120.

In one form, then, it can be said that FSD valve assembly 100 comprises a 2-stage pressure relief valve, comprising a damped main spool valve 110 and a pilot relief valve 120 which regulates the functioning of the main spool valve 110, and which itself is regulated by the pilot fluid supply.

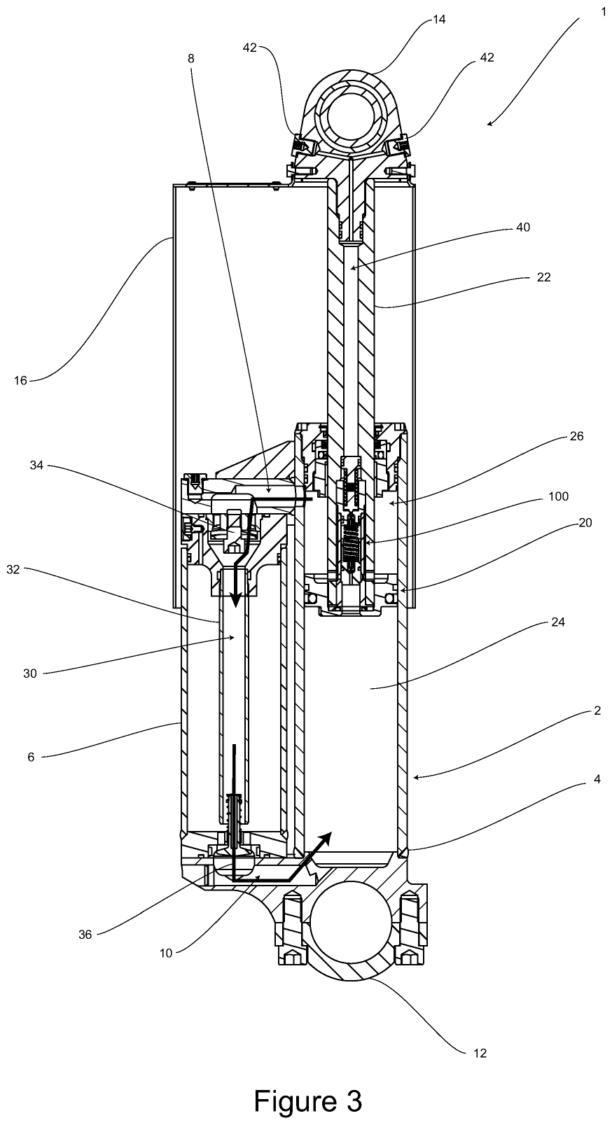

In use, during an extension stroke (see FIG. 3), the check valve 36 opens and fluid is drawn from the reservoir 30 into the main fluid chamber 24 via the second gallery 10, while fluid from the annulus fluid chamber 26 is displaced by the piston 20 through the first gallery 8 and flow regulating valve 34, into the reservoir 30.

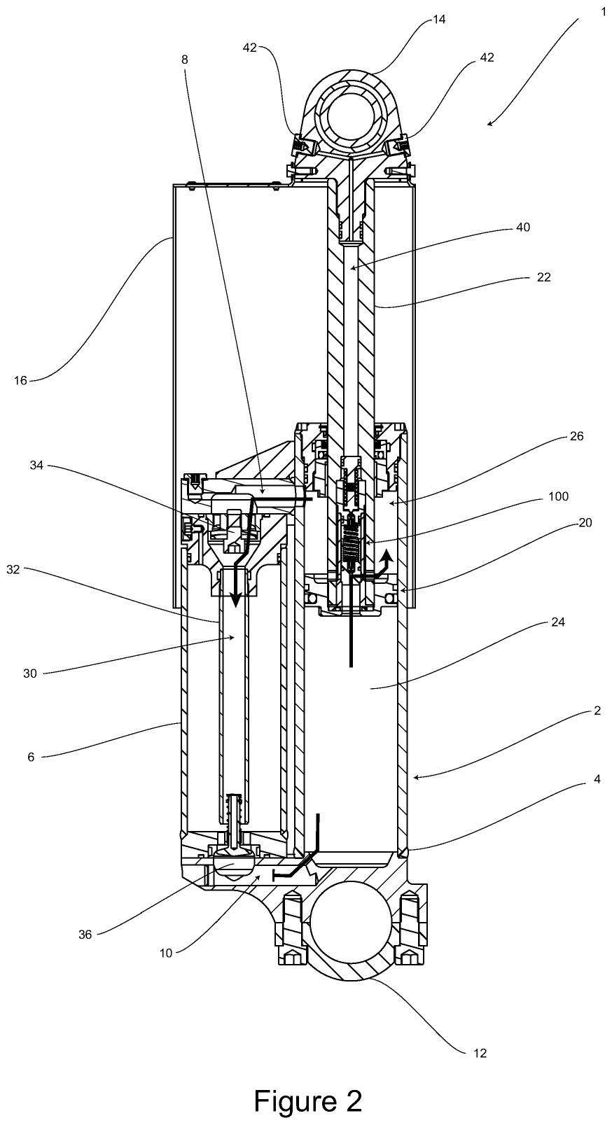

In use, during a compression stroke (see FIG. 2), the check valve 36 remains closed, and fluid from the main fluid chamber 24 displaces the pilot poppet 122 and subsequently the main poppet 112 from their closed positions, and the fluid from the main fluid chamber 24 is passed through pilot exhaust passageway 128 and bypass exhaust ports 115 to the annulus fluid chamber 26, wherein fluid from the annulus fluid chamber 26 is displaced by the piston rod 22 through the first gallery 8 and flow regulating valve 34, into the reservoir 30.

It will be appreciated that in both extension and compression strokes, that fluid is displaced from main cylinder 4 to the reservoir cylinder 6.

Once unseated, the damping of main poppet 112 by the pilot poppet 122 is such that a period of time may pass before it is reseated, and while the main poppet 112 is unseated, the bypass exhaust ports 115 are open in both compression and extension travel. In this way, the damper 1 can minimise heat generation during high frequency low amplitude road input. It will be appreciated that through modification of poppet sizing, spring rates, and spring pre-loads that the damping characteristics of the FSD valve are able to be adjusted to suit operational requirements of the system.

In use, ‘lockout’ is effected when pilot supply fluid is supplied against the blocking piston 132 increasing an extent of bias applied to maintain the pilot valve 120 closed, meaning no fluid can be exhausted from behind the main stage poppet 112, meaning the main poppet 112 remains in its closed position blocking bypass exhaust ports 115, meaning no fluid is passed from the main fluid chamber 24 to the annulus fluid chamber 26, and the length of the damper 1 is locked.

That is to say, the pilot supply actuates the blocking piston 132 that locks the pilot valve of the FSD valve. It follows that the pilot supply can be pressure regulated to control the pilot spring 124 preload and subsequently damping force.

The damper 1 according to the present disclosure minimises heat generation during high frequency low amplitude road input by creating a piston by-pass above a specified frequency input, such as 10 hz. A result of this is firm damping in all damper positions during low frequency input (braking, cornering). In addition to this, damper 1 advantageously comprises length lockout.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A hydraulic damper comprising:
a main cylinder;
a piston slidably moveable within the main cylinder in compression and extension, the piston dividing the main cylinder into a main fluid chamber and an annulus fluid chamber;
a piston rod extending from the piston through the annulus fluid chamber;
wherein the piston comprises a frequency sensitive damping (FSD) valve assembly configured to create a piston by-pass above a specified damper frequency, and is further configured to lock the length of the hydraulic damper.

2. The hydraulic damper as claimed in claim 1, further comprising:
a reservoir;
a first fluid passage extending between the annulus fluid chamber and the reservoir;
a second fluid passage extending between the reservoir and the main fluid chamber; and
a check valve positioned between the reservoir and the main fluid chamber to prevent flow from the main fluid chamber to the reservoir via the second fluid passage.

3. The hydraulic damper as claimed in claim 2, wherein in use, during a compression stroke, the check valve remains closed, and fluid in the main fluid chamber is passed by and through the FSD valve assembly to the annulus fluid chamber and then the reservoir via the first fluid passage.

4. The hydraulic damper as claimed in either claim 2 or claim 3, wherein in use, during an extension stroke, fluid is drawn from the reservoir to the main fluid chamber via the second fluid passage and check valve.

5. The hydraulic damper as claimed in any one of claims 2 to 4, wherein the FSD valve assembly comprises:
a main spool valve comprising a main poppet biased to prevent fluid from the main fluid chamber from bypassing the FSD valve assembly to the annulus fluid chamber, the main poppet comprising a control orifice through which fluid can pass from the main fluid chamber to a backside thereof; and
a pilot valve comprising a pilot poppet biased to prevent fluid passing from a backside of the main spool valve to the annulus fluid chamber via a pilot exhaust passageway,
wherein when pressure within the main fluid chamber exceeds the force exerted on the pilot poppet, the pilot poppet opens and fluid is released behind the main poppet through the pilot exhaust passageway, wherein the resultant pressure drop across the control orifice opens the main poppet, allowing fluid to flow from the main fluid chamber to the main fluid chamber, and
when pressure within the main fluid chamber falls below the force exerted on the pilot poppet, the pilot poppet closes, preventing the release of fluid behind the main poppet through the pilot exhaust passageway, wherein pressure equalises across the control orifice and the main poppet closes.

6. The hydraulic damper as claimed in claim 5, wherein the main poppet is biased to prevent fluid from the main fluid chamber from bypassing the FSD valve assembly to the annulus fluid chamber by a main spring.

7. The hydraulic damper as claimed in either claim 5 or claim 6, wherein the pilot poppet is biased to prevent exhaust of fluid from a backside of the main spool valve to the annulus fluid chamber by a pilot spring.

8. The hydraulic damper as claimed in claim 7, wherein the FSD valve assembly further comprises a blocking piston in fluid communication with a fluid supply for supplying a pilot fluid to the damper, the blocking piston biased against the fluid supply and the pilot poppet by the pilot spring, such that a variation of pressure exerted on the blocking piston by the fluid supply will vary the extent of bias applied to close the pilot poppet by the pilot spring.

9. The hydraulic damper as claimed in claim 8, wherein locking the length of the damper is effected when supply fluid is supplied against the blocking piston increasing an extent of bias applied to close the pilot valve, meaning no fluid can be exhausted from behind the main spool valve, meaning no fluid is passed from the main fluid chamber to the annulus fluid chamber, and the length of the damper is locked.

10. The hydraulic damper as claimed in either claim 8 or 9, wherein the fluid supply for supplying fluid to the damper comprises a vehicle hydraulic system.

11. The hydraulic damper as claimed in any one of claims 2 to 10, further comprising a flow regulating valve positioned between the annular fluid chamber and the reservoir.

12. A hydraulic damper comprising a main cylinder comprising a first end and a second end, a reservoir comprising an elongate body comprising a first end and a second end, the reservoir being positioned alongside of the main cylinder, a first fluid gallery extending between an annulus fluid chamber of the main cylinder and the reservoir at or toward the first end of each, a second fluid gallery extending between the reservoir and a main fluid chamber of the main cylinder and at or toward the second end of each, a flow regulating valve positioned between the first fluid gallery and the reservoir, a check valve positioned between the reservoir and the second fluid gallery to prevent back-flow from the main fluid chamber via the second fluid gallery, a piston slidably moveable within the main cylinder in compression and extension, the piston dividing the main cylinder into the main fluid chamber and the annulus fluid chamber, a piston rod extending from the piston through the annulus fluid chamber, the piston rod comprising a pilot fluid passageway extending therethrough from a first end, which is in fluid communication with the main fluid chamber, to a second end in fluid communication with a fluid supply for supplying a pilot fluid to the damper, and wherein the piston comprises a frequency sensitive damping (FSD) valve assembly which is positioned in the first end of the rod piston fluid passageway, which creates a piston by-pass above a specified damper frequency, and which locks the length of the damper when the fluid supply supplies pilot fluid to the damper.

13. A frequency sensitive damping (FSD) valve assembly for a hydraulic damper, the FSD valve assembly comprising a main spool valve and a pilot valve which regulates the functioning of the main spool valve, and which itself is regulated by a pilot fluid supply.

14. The FSD valve as claimed in claim 13, wherein the main spool valve comprises a main poppet biased to prevent fluid from a main fluid chamber from bypassing the FSD valve assembly to an annulus fluid chamber, a pilot valve comprising a pilot poppet biased to prevent fluid passing from a backside of the main spool valve to the annulus fluid chamber and to vary a degree of bias of the main spool valve, and a blocking piston biased against a fluid supply and the pilot poppet so as to vary a degree of bias of the pilot poppet.
